(19) United States
(12) Patent Application Publication
(10) Pub. No.: US 2022/0058640 A1
(43) Pub. Date: Feb. 24, 2022

(54) Transaction Processing Method, Transaction Processing Apparatus, Electronic Device and Storage Medium

(71) Applicant: Lifeng HUANG, Beijing (CN)

(72) Inventor: Lifeng HUANG, Beijing (CN)

(21) Appl. No.: 17/375,649

(22) Filed: Jul. 14, 2021

(30) Foreign Application Priority Data
Aug. 24, 2020 (CN) 202010860953.0

(51) Int. Cl. G06Q 20/38; G06Q 20/06; H04L 9/08

(52) U.S. Cl. CPC G06Q 20/3825; G06Q 20/3829; H04L 2209/56; H04L 9/0825; G06Q 20/065

(57) ABSTRACT

The present disclosure provides a transaction processing method, a transaction processing apparatus, an electronic device, and a storage medium, relating to the technical field of encrypted communications. The transaction processing method includes: constructing a payment transaction; obtaining a digital signature of the payment transaction based on a private key of a payer and storing the digital signature of the payment transaction; and broadcasting the payment transaction and the digital signature thereof to an account book network, so that a payee receives the payment transaction and the digital signature thereof from the account book network, constructs a collection transaction corresponding to the payment transaction after the validity is passed using a public key of the payer, and obtains a digital signature of the collection transaction based on a private key of the payee.

### CROSS REFERENCE TO RELATED APPLICATION

The present disclosure claims the priority to the Chinese patent application filed on Aug. 24, 2020 with the Chinese Patent Office with the filing No. 202010860953.0, and entitled “Transaction Processing Method, Transaction Processing Apparatus, Electronic Device, and Storage Medium”, which is incorporated herein by reference in its entirety.

### TECHNICAL FIELD

The present disclosure relates to the technical field of encrypted communications, in particular, to a transaction processing method, a transaction processing apparatus, an electronic device, and a storage medium.

### BACKGROUND ART

The double-entry bookkeeping method was first pioneered by the Romans and Jewish communities in the Middle East in early Middle Ages. The double-entry bookkeeping may be traced back to the 11^{th} century AD, and after a few hundred years of slow evolution and development, it gradually became mature in the late 15^{th} century, and began to be applied on a large scale. That is to say, it has been existed for about 1000 years, and used on a large scale for about 500 years.

The occurrence of any economic business will cause increase or decrease of at least two items, i.e., assets and liabilities, and the increased and decreased amounts are equal. Therefore, when reflecting each item of economic business, registration should be made simultaneously in at least two related accounts with equal amounts. This method of making registration in two or more accounts linked to each other for each item of economic business that occurs with equal amounts is called as double-entry bookkeeping. The double-entry bookkeeping method plays an important role in the accounting method system, because in daily accounting work, the double-entry bookkeeping should be applied from preparation of accounting documents to registration of account books. It lays the foundation of modern business, and is a standard method and system for modern business and other organizations to record financial transactions, thus having quite important status and significance. The double-entry bookkeeping has an obvious characteristic: for each item of economic business that occurs, trial balance should be carried out on at least two virtual accounts interconnectedly according to required accounting subjects.

In daily use scenes of the double-entry bookkeeping method, most of the time, accounting documents such as invoices or vouchers, and receipts are indispensable (hereinafter, invoice will be used uniformly to refer to such type of accounting documents). The invoice is a business document issued by a seller to a buyer and collected by the buyer in economic activities. It includes business-related information such as name, quantity, unit, unit price, and transaction date of goods or services provided, is an original basis for accounting, and is also an important basis for inspection by various related organizations. For internal auditing and checking, each invoice must have a unique journal account number, so as to prevent duplication or skipping of the invoice. In short, the invoice is the original proof of cost, expense or income that occurred. For companies, the invoice is mainly the basis for making accounts in the companies, and meanwhile is also expense certificate for tax payment; and for employees, the invoice is mainly used for reimbursement.

Due to the above characteristics of the double-entry bookkeeping method and its relationship with the invoice, the existing double-entry bookkeeping method has the problems of a large accounting workload, low bookkeeping efficiency, cumbersome related invoice practices, and difficult digitization.

### SUMMARY

For the reasons listed above, an objective of embodiments of the present disclosure is to provide a transaction processing method, a transaction processing apparatus, an electronic device, and a storage medium, so as to eliminate various problems brought about by the double-entry bookkeeping method.

An embodiment of the present disclosure provides a transaction processing method applied to a payer, wherein the method may include: constructing a payment transaction; digitally signing the payment transaction using a private key of the payer, to obtain a digital signature of the payment transaction; storing the payment transaction and the digital signature of the payment transaction; and broadcasting the payment transaction and the digital signature of the payment transaction to an account book network, so that a payee receives the payment transaction and the digital signature of the payment transaction from the account book network, verifies the validity of the payment transaction, verifies the validity of the digital signature of the payment transaction using a public key of the payer, constructs a collection transaction corresponding to the payment transaction after the validity of the payment transaction and the validity of the digital signature of the payment transaction are passed, and digitally signs the collection transaction using a private key of the payee, to obtain a digital signature of the collection transaction.

In the above implementation, the payer and the payee only need to locally record the transaction related to oneself, but do not have to record transactions irrelevant thereto, thus the transaction recording workload is reduced, the transaction recording efficiency is improved, and meanwhile, the public and private keys are used to verify the transaction information, then cross verification and secondary confirmation of identity and transaction are realized, the counterfeiting space is reduced, the transaction safety is improved, and the paper invoice or voucher does not need to be issued, thus reducing the bookkeeping cost.

Optionally, the method further may include: generating the private key of the payer and the public key of the payer based on an algorithm specified by the account book network, and storing the private key of the payer and the public key of the payer.

In the above implementation, the transaction content is digitally signed with the key generated on the basis of the algorithm specified by the account book network, thus the legality of the transaction record can be ensured, the invoice or the like is not needed for the transaction check, the invoice-related workload and intermediate sections are reduced, and the convenience and efficiency of the transaction and auditing are improved.

Optionally, the method further may include: sending the public key of the payer to the account book network for registration; and receiving and storing a payer identifier returned by the account book network when the registration succeeds, wherein the payer registers only when accessing the account book network for the first time, and generates the private key of the payer and the public key of the payer only in the event that registration is needed.

In the above implementation, as the identity verification of the payer and the payee is performed using the digital signature, no separate login operation is needed when the transaction data is transferred each time, and the registration only needs to be performed once, thus improving the bookkeeping efficiency and safety.

An embodiment of the present disclosure further provides a transaction processing method applied to a payee, wherein the method may include: receiving the payment transaction and the digital signature of the payment transaction from the account book network; verifying the validity of the payment transaction, and verifying the validity of the digital signature of the payment transaction using the public key of the payer; constructing, after the validity of the payment transaction and the validity of the digital signature of the payment transaction are passed, a collection transaction corresponding to the payment transaction; and digitally signing the collection transaction using the private key of the payee, to obtain the digital signature of the collection transaction.

In the above implementation, the payee and the payer cooperate with each other, and only need to locally record the transaction related to oneself, thus the transaction recording workload is reduced, the transaction recording efficiency is improved, and meanwhile, the public and private keys are used to verify the identity, then cross verification and secondary confirmation of identity and transaction are realized, the counterfeiting space is reduced, the transaction safety is improved, and the paper invoice or voucher does not need to be issued, thus reducing the bookkeeping cost.

Optionally, after acquiring the collection transaction and the digital signature of the collection transaction, the payee may send the collection transaction and the digital signature of the collection transaction to the account book network, so that the account book network, after verifying the collection transaction and the digital signature of the collection transaction, stores the collection transaction and the digital signature of the collection transaction.

Optionally, after completing the storage of the collection transaction and the digital signature of the collection transaction, the coordinator node of the account book network may actively notify the payer and the payee that the identified payment transaction has been written into the account book.

Optionally, the coordinator node of the account book network may notify the payee of an intermediate processing result or progress in the process of processing the collection transaction.

Optionally, the method further may include: generating the private key of the payee and the public key of the payee based on an algorithm specified by the account book network, and storing the private key of the payee and the public key of the payee.

In the above implementation, the transaction is digitally signed with the key generated on the basis of the algorithm specified by the account book network, thus the legality of the transaction record can be ensured, the invoice or the like is not needed for the transaction check, the invoice-related workload and intermediate sections are reduced, and the convenience and efficiency of the transaction and auditing are improved.

Optionally, the method further may include: sending the public key of the payee to the account book network for registration; and receiving and storing a payee identifier returned by the account book network when the registration succeeds, wherein the payee registers only when accessing the account book network for the first time, and generates the private key of the payee and the public key of the payee only in the event that registration is needed.

Optionally, the constructing a collection transaction corresponding to the payment transaction may include: determining a transaction action type of the payment transaction, and constructing a corresponding collection transaction according to the determined transaction action type.

In the above implementation, the payee determines the collection transaction corresponding to the payment transaction based on the payment transaction, the payee only needs to store the collection transaction, does not need to store the payment transaction, thus the bookkeeping workload is reduced, thereby improving the bookkeeping efficiency.

An embodiment of the present disclosure further provides a transaction processing method applied to an account book network, wherein the method may include: receiving a payment transaction and a digital signature of the payment transaction sent by a payer; verifying the validity of the payment transaction, and verifying the validity of the digital signature of the payment transaction using a public key of the payer; sending, after the validity of the payment transaction and the validity of the digital signature of the payment transaction are passed, the payment transaction and the digital signature of the payment transaction to the payee directly or indirectly, so that the payee receives the payment transaction and the digital signature of the payment transaction from the account book network, verifies the validity of the payment transaction, and verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using the private key of the payee to obtain the digital signature of the collection transaction; receiving the collection transaction and the digital signature of the collection transaction sent by the payee; verifying the validity of the collection transaction, and verifying the validity of the digital signature of the collection transaction using the public key of the payee; and storing, after the validity of the collection transaction and the validity of the digital signature of the collection transaction are passed, the collection transaction and the digital signature of the collection transaction, and sending the collection transaction and the digital signature of the collection transaction directly or indirectly to the payer.

In the above implementation, through the cooperation of the account book network with the payee and the payer, only the transaction related to oneself needs to be locally recorded, but the counterparty's transaction does not need to be recorded, thus the transaction recording workload is reduced, the transaction recording efficiency is improved, and meanwhile, the public and private keys are used to verify the identity, then cross verification and secondary confirmation of identity and transaction are realized, the counterfeiting space is reduced, the transaction safety is improved, and the paper invoice or voucher does not need to be issued, thus reducing the bookkeeping cost of the transaction.

Optionally, the account book network may verify the transaction time of the payment transaction or the collection transaction, so as to determine whether the transaction is reasonable.

Optionally, the payment transaction and the digital signature of the payment transaction are sent to the payee in a direct manner or in an indirect manner, wherein the direct manner may include that the payment transaction and the digital signature of the payment transaction are sent to the payee point-to-point through the node of the account book network, and wherein the indirect manner may include that the account book network enables other nodes, by broadcasting in the whole network, to indirectly send the payment transaction and the digital signature of the payment transaction to the payee.

Optionally, the coordinator node of the account book network may notify the payer of an intermediate processing result or progress in the process of processing the payment transaction and the digital signature of the payment transaction.

An embodiment of the present disclosure further provides a transaction processing apparatus applied to a payer, wherein the apparatus may include: a payment transaction constructing module, configured to construct a payment transaction; a first signing module, configured to digitally sign the payment transaction using a private key of the payer, to obtain a digital signature of the payment transaction; a first storage module, configured to store the payment transaction and the digital signature of the payment transaction; and a broadcasting module, configured to broadcast the payment transaction and the digital signature of the payment transaction to the account book network, so that the payee receives the payment transaction and the digital signature of the payment transaction from the account book network, verifies the validity of the payment transaction, and verifies the validity of the digital signature of the payment transaction using a public key of the payer, constructs a collection transaction corresponding to the payment transaction after the validity of the payment transaction and the validity of the digital signature of the payment transaction are passed, and digitally signs the collection transaction using a private key of the payee to obtain the digital signature of the collection transaction.

Optionally, the transaction processing apparatus further may include: a first key module, configured to generate the private key of the payer and the public key of the payer based on an algorithm specified by the account book network, and store the private key of the payer and the public key of the payer.

Optionally, the transaction processing apparatus further may include: a first registration module, configured to send the public key of the payer to the account book network for registration; receive and store a payer identifier returned by the account book network when the registration succeeds, wherein the payer registers only when accessing the account book network for the first time, and generates the private key of the payer and the public key of the payer only when registering.

An embodiment of the present disclosure further provides a transaction processing apparatus applied to a payee, wherein the apparatus may include: a first receiving module, configured to receive a payment transaction and a digital signature of the payment transaction from an account book network; a first verifying module, configured to verify the validity of the payment transaction, and verify the validity of the digital signature of the payment transaction using the public key of the payer; a collection transaction constructing module, configured to construct, after the validity of the payment transaction and the validity of the digital signature of the payment transaction are passed, a collection transaction corresponding to the payment transaction; and a second signing module, configured to digitally sign the collection transaction using a private key of the payee, to obtain the digital signature of the collection transaction.

Optionally, the transaction processing apparatus further may include: a second key module, configured to generate the private key of the payee and the public key of the payee based on an algorithm specified by the account book network, and store the private key of the payee and the public key of the payee.

Optionally, the transaction processing apparatus further may include: a second registration module, configured to send the public key of the payee to the account book network for registration; receive and store a payee identifier returned by the account book network when the registration succeeds, wherein the payee registers only when accessing the account book network for the first time, and generates the private key of the payee and the public key of the payee only when registering.

Optionally, the collection transaction constructing module may be specifically configured to: determine a transaction action type of the payment transaction, and determine a collection transaction corresponding to the transaction action type.

An embodiment of the present disclosure further provides a transaction processing apparatus applied to an account book network, wherein the apparatus includes: a second receiving module, configured to receive the payment transaction and the digital signature of the payment transaction sent by the payer; a second verifying module, configured to verify the validity of the payment transaction, and verify the validity of the digital signature of the payment transaction using the public key of the payer; a sending module, configured to send, after the validity of the payment transaction and the validity of the digital signature of the payment transaction are passed, the payment transaction and the digital signature of the payment transaction to the payee directly or indirectly, so that the payee receives the payment transaction and the digital signature of the payment transaction from the account book network, verifies the validity of the payment transaction, and verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using the private key of the payee to obtain the digital signature of the collection transaction; a third receiving module, configured to receive the collection transaction and the digital signature of the collection transaction sent by the payee; a third verifying module, configured to verify the validity of the collection transaction, and verify the validity of the digital signature of the collection transaction using the public key of the payee; and a storing module, configured to store, after the validity of the collection transaction and the validity of the digital signature of the collection transaction are passed, the collection transaction and the digital signature of the collection transaction, and sending the collection transaction and the digital signature of the collection transaction directly or indirectly to the payer.

An embodiment of the present disclosure further provides an electronic device, wherein the electronic device may include a memory and a processor, the memory stores a program instruction, and when the processor reads and runs the program instruction, the steps in any one of the above implementations may be executed.

An embodiment of the present disclosure further provides a storage medium, wherein a computer program instruction is stored in the storage medium, and when the computer program instruction is read and run by a processor, the steps in any one of the above implementations may be executed.

### BRIEF DESCRIPTION OF DRAWINGS

In order to more clearly illustrate technical solutions of embodiments of the present disclosure, accompanying drawings which need to be used in the embodiments of the present disclosure will be introduced briefly below, and it should be understood that the accompanying drawings below merely show embodiments of the present disclosure, therefore, they should not be considered as limitation on the scope, and those ordinarily skilled in the art still could obtain other relevant accompanying drawings according to these accompanying drawings, without using any creative efforts.

FIG. 1 is a schematic flowchart of a transaction processing method applied to a payer provided in an embodiment of the present disclosure;

FIG. 2 is a schematic flowchart of the transaction processing method applied to an account book network provided in an embodiment of the present disclosure;

FIG. 3 is a schematic flowchart of the transaction processing method applied to a payee provided in an embodiment of the present disclosure;

FIG. 4 is a modular schematic diagram of a transaction processing apparatus applied to a payer provided in an embodiment of the present disclosure;

FIG. 5 is a modular schematic diagram of the transaction processing apparatus applied to a payee provided in an embodiment of the present disclosure; and

FIG. 6 is a modular schematic diagram of the transaction processing apparatus applied to an account book network provided in an embodiment of the present disclosure.

Reference signs: 40—transaction processing apparatus; 41—payment transaction constructing module; 42—first signing module; 43—first storage module; 44—broadcasting module; 50—transaction processing apparatus; 51—first receiving module; 52—first verifying module; 53—collection transaction constructing module; 54—second signing module; 60—transaction processing apparatus; 61—second receiving module; 62—second verifying module; 63—sending module; 64—third receiving module; 65—third verifying module; 66—storage module.

### DETAILED DESCRIPTION OF EMBODIMENTS

In order to make objectives, technical solutions, and advantages of embodiments of the present disclosure clearer, the technical solutions in the embodiments of the present disclosure will be described below in conjunction with accompanying drawings in the embodiments of the present disclosure. Apparently, some but not all embodiments of the present disclosure are described. Based on the embodiments in the present disclosure, all of other embodiments, obtained by those ordinarily skilled in the art without using any creative efforts, shall fall within the scope of protection of the present disclosure.

The applicant found that the double-entry bookkeeping method is a global standard for bookkeeping, but it is per se tedious, and causes a series of disadvantages and problems due to introduction of invoice (or other accounting documents). In the following, the applicant will first introduce an analysis framework used by the applicant, and then analyze the double-entry bookkeeping method using this framework.

1. Introduction to the Analysis Framework

Many scenarios of organizations and institutions using the double-entry bookkeeping method always may relate to three sections: invoicing (invoice production); reimbursement (invoice use); and bookkeeping (unrelated to invoice). The double-entry bookkeeping method and use of invoice further involve a plurality of stakeholders: consumer; enterprise and organization (invoicing party or invoice collecting party); tax authority; enterprise stakeholder; and the whole society. In the following, the three sections in the flow are first analyzed, and then the analysis is made from perspectives of various stakeholders.

2. Section 1: Problems in the Invoicing (Invoice Production) Section

A. Enterprises need to purchase a dedicated tax control machine from the tax department to print invoices, update relevant software and hardware regularly, purchase relevant consumables during use, and may also need someone to maintain these software and hardware, all of which are additional expenditures for the enterprises;

B. Because of the problem of tax control cost, many middle and small-sized enterprises even cannot invoice, which leads to reduced tax control capability of relevant departments, and easily causes the loss of tax;

C. Due to the existence of invoices, in practical use, cross-agency auditing cannot be carried out at all, which leads to the problem that transaction counterfeiting or invoice counterfeiting cannot be found.

3. Section 2: Problems in the Reimbursement (Invoice Use) Section

It is necessary to collect invoices or vouchers in the reimbursement section, but invoices or vouchers, and receipts are easily counterfeited. Fraud cases of false invoice reimbursement have the following common methods.

A. Fake Invoice Entry, False Reimbursement

In order to defraud reimbursement from the company, the company employee directly counterfeits, alters or purchases fake invoices on the market that are not monitored by the tax authority, and makes false reimbursement and entry to the company, to cheat and embezzle the company's property;

B. Applying for Reimbursement with False Invoice Content

Although the company employee provides real invoice, the consumption content of the invoice is not used for working purpose, and does not belong to the reimbursement range permitted by the company. The employee counterfeits false consumption on this basis, and reimburses it to the company to embezzle the company's property.

C. Real Invoice Content, Fictitious Purpose

The company employee falsely claims that the invoice acquired from his/her real consumption is used for business development of the company, and reimburses it to the company to embezzle the company's money. There are four common types of invoice situations with false content: repeated reimbursement; content inconsistency; time mismatch; and no real accomplishment of transaction.

4. Section 3: Problems in the Bookkeeping Section (Unrelated to Invoice)

A. All of the records of one item of economic business are left out or re-recorded;

B. Both debtor and lender of one item of economic business have the same mistake in amount during the preparation of accounting entry;

C. An account to be borrowed and an account to be credited are reversed or accounting subject titles are misused when the accounting entry is prepared for one item of economic business;

D. Two or one of debtor and lender of the accounting entry wrongly records the accounting subject when posting up a general ledger; and

E. The amount of debit items or credit items is accidentally increased or missed by one, just compensating for each other.

5. Perspective 1: Analysis from Consumer's Perspective

In general, if there is a demand for invoice, after purchasing goods and services, the consumer needs to provide his or her name or tax ID of the company to the seller, and then takes a certain time to wait for the seller to invoice; once many people need to have the invoices, the consumer has to wait patiently for a long period of time; after receiving the paper invoice, the consumer should carefully glue the invoice onto the bottom sheet, and then applies for leaders of levels in the unit to sign the invoice, and then carefully delivers the prepared invoice to the financial personnel, and then waits for half a week or longer to see that the reimbursement funds are returned to his or her account. Moreover, if the invoice is accidentally lost, the person concerned either takes up the cost of consumption that cannot be reimbursed, or has the invoice to be reissued and takes up the seller's loss of additional tax points.

6. Perspective 2: Analysis from Institution's Perspective

A. Invoice Issuer

The enterprises acquire the conventional invoices all by purchasing. After having got the invoices, in order to support the invoicing, the enterprises also have to purchase dedicated hardware equipment such as printer and printing paper, and after the consumer or the purchasers check out, a professional worker is required to be independently responsible for invoicing, thus the consumable cost and the labor cost invested are definitely not a small amount;

B. Receiver of Invoice

Multiple posts and professional financial personnel need to be set up to audit the invoices applied for reimbursement, but due to information asymmetry and limited human resources, organizations such as enterprises cannot complete the investigation and adjustment of authenticity of the invoices, and fake invoices often cause a large number of risk expenditures and property loss to enterprises.

7. Perspective 3: Analysis from the Perspective of Tax Related Agencies

A. Not to mention the falsification and trafficking of the conventional paper invoices, even electronic invoices currently with tax control code still may be caught in such a situation that one invoice is issued multiple times and used multiple times (several people use one electronic invoice). Meanwhile, the electronic invoices in China are distributed on the third party service provider platform or the self-built platform, and the invoice data information cannot be intercommunicated with each other, then the tax authority can hardly monitor the invoices, moreover, as long as the reimbursing person needs, he or she absolutely can obtain an invoice with extremely flexible amounts from the invoice issuer by buying the tax points. It has become a public fact that the invoice is in name only.

B. In addition, in order to evade tax, the phenomenon that the seller does not issue invoices or invoices less is common, and various illegal invoicing behaviors such as free tampering and free fabricating not only make the rare public financial funds to be secretly stolen, but also cause a lot of loss of tax sources.

8. Perspective 4: Analysis from the Perspective of Enterprise Stakeholders

A. If a financial fraud of an enterprise is disclosed, it has a quite large destructive effect, and may bring direct and indirect impairments to employees, shareholders, and creditors of the enterprise, and business suppliers, dealers and so on of the enterprise;

B. if the financial fraud of the enterprise is not disclosed, it is unfair to all enterprises for honest operation, and the benefits of customers, consumers, shareholders, creditors, business suppliers, dealers and so on will also be compromised.

9. Perspective 5: Analysis from the Perspective of the Whole Society

A. Data island effect: the double-entry bookkeeping method requires that each bookkeeping entity has an independent account book, and this will lead to the data island effect, which is one of the fundamental causes for process redundancy and inefficiency in the digital age;

B. Data storage efficiency is low, and a large amount of storage space is occupied; even if the system using the double-entry bookkeeping method is digitalized, it still will cause the problem of wasting the data storage space; and

C. Frauds of enterprises have destructive impacts to the value of the whole society, and have the adverse influence that bad money drives out good.

10. Summary of Disadvantages

To summarize the analysis of the above flow sections and perspectives of different stakeholders, the disadvantages of the double-entry bookkeeping method may be obtained.

A. It is easy to counterfeit or make mistake: the bookkeeping section and the sections of invoicing and using the invoices are easily counterfeited or make mistakes in work, and the checking and correcting costs are high;

B. The efficiency is low: because double records are required, it causes heavy workload (for the accounting personnel), low efficiency, and is prone to errors;

C. The user experience is poor: as the invoices or vouchers need to be issued, collected, and used, the user experience is poor, and unnecessary troubles are brought to consumers, enterprises, and organizations;

D. Data island effect: one account book for each entity will cause data fragmentation and isolation of the account books, and they cannot be verified with each other, thus resulting in a lot of repeated work, impossibility or difficulty in carrying out auditing, redundant flow, and impossibility of simplification, and low efficiency; and

E. The storage efficiency is low: the double-entry bookkeeping method also will lead to low storage efficiency, and occupy a large amount of additional storage space.

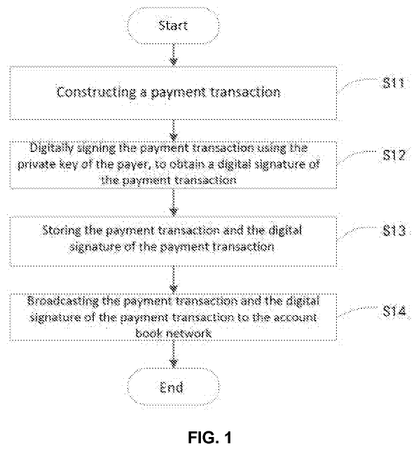

In order to solve the above problems of the double-entry bookkeeping method, an embodiment of the present disclosure provides a transaction processing method applied to a payer provided in an embodiment of the present disclosure. Referring to FIG. 1, FIG. 1 is a schematic flowchart of a transaction processing method applied to a payer provided in an embodiment of the present disclosure. Specific steps of the transaction processing method may include:

step S11: constructing a payment transaction.

First, the payer, the payee, and the account book network in the present embodiment are described. The account book network may be referred to as a distributed account book or a distributed account book network. The distributed account book is a database shared, copied, and synchronized among network members. The distributed account book records transactions between network participants, such as exchange of assets or data. The participants in the network restrict and negotiate updates to records in the account book according to a consensus principle. No intermediate third-party arbitration mechanism (such as financial institution or clearing house) participates. Each record in the account book has a time stamp and a unique digital signature, which makes the account book become an auditable history record of all transactions in the network.

Optionally, the above account book network may be a common account book, a private account book or an alliance account book, or may also be a certain kind of mixed and multi-center distributed account book. The public account book is also commonly referred to as a permission-free account book, any person may participate in data maintenance and reading of the distributed account, then the application program is easily deployed, and the public account book is completely decentralized and not controlled by any institution. The alliance account book is a distributed account that needs registration permission, and such distributed account book is also referred to as a permission account. The alliance account book is merely limited to alliance members to participate, and the alliance scale may be as large as between countries, and may also be between different organizations or enterprises. The private account book is merely limited to use by enterprises or individuals, and cannot completely solve the trust problem, but may improve the audibility.

The account book network mainly may have two nodes: a user node and a coordinator node. The main participant therein is referred to as a coordinator node or coordinator, a plurality of coordinator nodes are usually combined into one node group, most of the tasks are cooperatively completed by one coordinator node group, many sections in the whole consensus process may be completed together by a plurality of different node groups, and each node group is responsible for a certain section therein. The account book network may be composed of a plurality of nodes connected through a communication connection mode such as Internet or local area network.

The coordinator node may be, for example, divided into several types of roles according to functions realized: caching, checking, executing, reaching consensus, and/or verifying. Functions of the above roles may be accomplished by, for example, one or more node groups.

The payee and the payer may both be regarded as common users of the account book network, and the coordinator, as a special node in the account book network, needs to assume and complete more tasks and responsibilities than common users. Users using the account book network generally need to register in advance on the account book network as registered users. Exemplarily, the payer may be a user and a registered user of the account book network, a transfer initiator, or a transaction initiator; and the payee may be a user and a registered user of the account book network, a transfer receiver, or a transaction confirmer. For example, in the case of a store and a customer, the customer is the payer, and the store receiving the payment is the payee.

Exemplarily, the content of the transaction initiated by the payer may include transaction action of buying/selling (receiving/sending, borrowing/lending, etc.) and specific transaction amount and/or quantity, payee address or payee account identifier, and may further include payer account identifier and/or transaction time. Optionally, when the assets involved in the transaction include a plurality of types, the payment transaction further needs to include asset type identifiers. Optionally, transaction description or postscript may also be contained according to actual use requirements.

The payer or the payee in the present embodiment may register in advance in the account book network and then perform the transaction, that is, after the payer or the payee creates a key pair, a public key is used to register in the account book network, the account book network creates an account corresponding to this public key, and assigns an account identifier to this account, wherein an expression form of the account identifier may be a character string or a file, the file may be referred to as a digital certificate, and in addition to the account identification information, the digital certificate also may contain richer additional information. Optionally, the account identifier also may be created by the user himself in addition to being allocated to the user by the account book network.

Optionally, the payer or the payee in the present embodiment may also perform a transaction without pre-registration, but the transaction must contain the public key of the user, which is equivalent to taking the public key as the account identifier, also referred to as an account address. Optionally, there may be no need to register again when the transaction is performed again after the payer or payee has registered.

Optionally, the above registration manner may be a non-centralized registration manner. In the present embodiment, apart from being generated by the payer or the payee himself/herself, the account book network also may complete the registration of the payer or the payee in a centralized manner, wherein a pair of public and private keys of the payer and a pair of public and private keys of the payee are generated and assigned by an authoritative specified mechanism, and the user identifier is returned to the payee and the payer.

Step S12: digitally signing the payment transaction using the private key of the payer, to obtain a digital signature of the payment transaction.

Optionally, the public keys and the private keys of the payer and the payee in the present embodiment may be generated using a plurality of different optional algorithms. For example, the following public key signing algorithms may be used: RSA, secp256k1, sm2, ed25519, etc., wherein sm2 is a standard public key signing algorithm in China. Different account book networks may predefine different algorithms as public key and private key generation algorithms specific thereto. It is further possible that the same account book network may select different algorithms to generate the public and private keys of the payer and the public and private keys of the payee, respectively.

In the present step, the transaction content is signed in a digital signature manner, and the public and private keys for signature and verification may be public and private keys generated by the payer when registering on the account book network, can replace the invoice, and play a role of cross validation and secondary confirmation of identity and transaction, thereby reducing the above drawbacks brought about by the invoices, realizing more efficient and more secure transaction authentication, facilitating subsequent auditing, and being conducive to reducing the associated costs.

Therefore, in the present embodiment, the payment transaction and the digital signature of the payment transaction further may be sent to the account book network, so that the account book network may verify the validity of the payment transaction, and verify the validity of the payment transaction signature using the public key of the payer. After the validity verification is passed, the payment transaction and the digital signature of the payment transaction are stored, and sent to the payee, so that the transaction content can be efficiently, securely, and accurately verified and audited.

Generally, before step S12 is executed, the payer has generated and stored the private key of the payer and the public key of the payer based on the algorithm specified by the account book network, and sends the public key of the payer to the account book network for registration, and the payer has received and stored a payer identifier generated by the account book network after the registration succeeds.

Generally, the same user node may be a payer or a payee in different transaction scenarios, and the same user node may use one pair or more pairs of keys, and may use different key pairs when performing a collection transaction and a payment transaction, respectively, at this time, the corresponding account addresses (collection address and payment address) are also different.

Step S13: storing the payment transaction and the digital signature of the payment transaction.

Generally, each payer and each payee should have one independent local account book, which account book may be a database for storing relevant contents such as transaction content, digital signature, account identifier, and amount of money.

Generally, before sending the payment transaction and the digital signature of the payment transaction to the account book network for the first time, the payer needs to complete the registration on the account book network, and specific steps thereof may include: sending the public key of the payer to the account book network for registration; receiving and storing a payer identifier returned by the account book network when the registration succeeds, wherein the payer registers only when accessing the account book network for the first time, and generates the private key of the payer and the public key of the payer only when registering.

Step S14: broadcasting the payment transaction and the digital signature of the payment transaction to the account book network, so that the payee receives the payment transaction and the digital signature of the payment transaction from the account book network, verifies the validity of the payment transaction, verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using the private key of the payee to obtain the digital signature of the collection transaction.

Optionally, as an optional embodiment, the payer public key of the payer may be additionally sent after the payment transaction and the digital signature of the payment transaction, then the public key of the user does not need to be provided at the time of registration, the payer public key is sent additionally at each time of the transaction. Correspondingly, the payee is in the same case, and will not be described later.

Optionally, the payer may broadcast the payment transaction and the digital signature of the payment transaction to the whole network through the Gossip protocol or other broadcast protocols, so as to be received by the account book network.

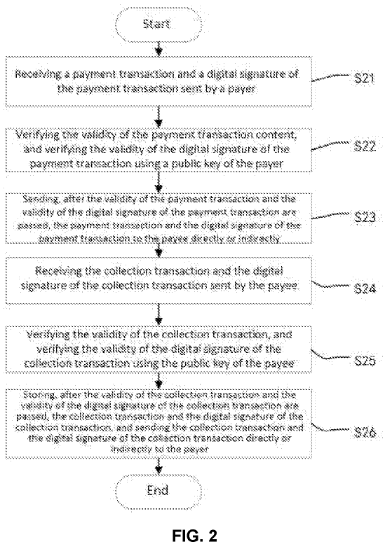

Corresponding to the above transaction processing method applied to a payer, an embodiment of the present disclosure provides a transaction processing method applied to an account book network. With reference to FIG. 2, FIG. 2 is a schematic flowchart of a transaction processing method applied to an account book network provided in an embodiment of the present disclosure. Specific steps of the transaction processing method may include:

Step S21: receiving a payment transaction and a digital signature of the payment transaction sent by a payer.

Step S22: verifying the validity of the payment transaction, and verifying the validity of the digital signature of the payment transaction using a public key of the payer.

Exemplarily, the step of verifying the validity of the payment transaction at least may include the following details, for example, it is necessary to verify whether account addresses of the payer and the payee are legal and whether accounts corresponding to identifiers of the payer and payee exist based on the payment transaction or the collection transaction. Optionally, it may be also necessary to verify whether account balance of the payer satisfies transaction amount of the payment transaction, or whether the transaction amount exceeds an allowable range of amount, for example, the transaction amount cannot be negative, zero, and cannot exceed the maximum allowable transaction amount.

Optionally, the account book network further may verify the transaction time of the payment transaction or the collection transaction, and determine whether the transaction is reasonable. For example, when the transaction time is Beijing time 20:22 PM on Apr. 27, 2020, if the system time is earlier than the transaction time, it is indicated that the transaction time might be unreasonable.

Step S23: sending, after the validity of the payment transaction and the validity of the digital signature of the payment transaction are passed, the payment transaction and the digital signature of the payment transaction to the payee directly or indirectly, so that the payee receives the payment transaction and the digital signature of the payment transaction from the account book network, verifies the validity of the payment transaction, and verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using the private key of the payee to obtain the digital signature of the collection transaction.

Step S24: receiving the collection transaction and the digital signature of the collection transaction sent by the payee.

Step S25: verifying the validity of the collection transaction, and verifying the validity of the digital signature of the collection transaction using the public key of the payee.

Step S26: storing, after the validity of the collection transaction and the validity of the digital signature of the collection transaction are passed, the collection transaction and the digital signature of the collection transaction, and sending the collection transaction and the digital signature of the collection transaction directly or indirectly to the payer.

With regard to the step of sending the payment transaction and the digital signature of the payment transaction to the payee directly or indirectly in the above, “directly” means that the payment transaction and the digital signature of the payment transaction sent to the payee point-to-point through the node of the account book network, and “indirectly” means that the account book network enables other nodes, by broadcasting in the whole network, to indirectly send the payment transaction and the digital signature of the payment transaction to the payee.

Optionally, in addition to the above processing, the coordinator node in the account book network further may perform any other necessary work for the payment transaction, including but not limited to executing method processing, locking relevant assets, reaching consensus on transaction outcome, writing transaction into the account book and/or tracing sources, etc. The above processing may be performed by one coordinator independently or by a plurality of coordinators in cooperation. The work in these sections may be done synchronously and serially, or may be done asynchronously and concurrently.

Optionally, the coordinator node in the account book network further may notify the payer of an intermediate processing result, progress in the intermediate section of processing the payment transaction and the digital signature of the payment transaction.

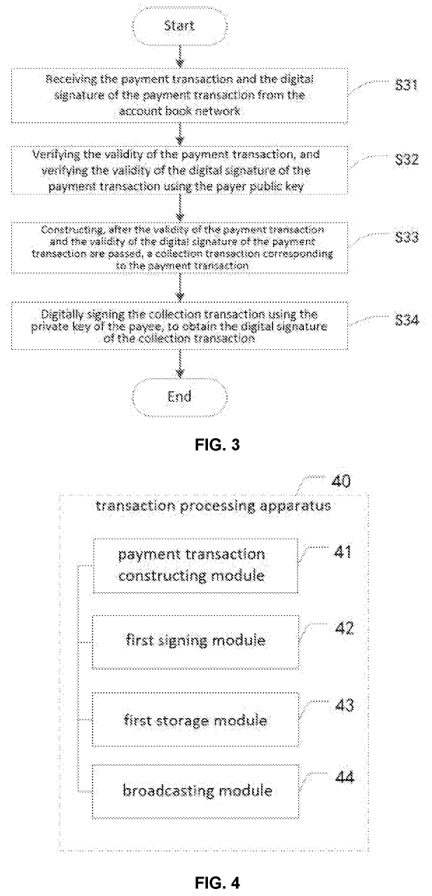

Corresponding to the above transaction processing method applied to a payer and an account book network, an embodiment of the present disclosure provides a transaction processing method applied to a payee. With reference to FIG. 3, FIG. 3 is a schematic flowchart of a transaction processing method applied to a payee according to an embodiment of the present disclosure. Specific steps of the transaction processing method may include:

Step S31: receiving the payment transaction and the digital signature of the payment transaction from the account book network.

The payee in the present embodiment is a passive party in the transaction, for example, in a transaction for selling item between a store and a customer, the store receiving the payment is the payee. For example, the payment transaction may include transaction actions such as buying/selling, receiving/sending, debiting/crediting and specific amount of money, and further may include other contents such as remarks of transaction item, transaction time, and transaction notes.

Optionally, after receiving the payment transaction and the digital signature of the payment transaction, the payee further may choose not to process or refuse to collect the payment.

For example, if the payee does not process, it will cause timeout (the timeout period is specified in the payment transaction, or is a default parameter of the system) of the payment transaction. For example, for the timed-out payment transaction, a timeout transaction corresponding to the payment transaction will be initiated by the account book network (a designated node in the account book network), and funds or assets involved in the payment transaction are returned to the payer.

For another example, if selecting to refuse to collect the payment, the payee may initiate a rejection transaction corresponding to the payment transaction, with the same purpose of returning the funds or assets involved in the payment transaction to the payer.

Optionally, the payment transaction and the digital signature of the payment transaction may be actively pushed by the coordinator node in the account book network to the payee, and may also be actively acquired by the payee using a pull mode.

Step S32: verifying the validity of the payment transaction, and verifying the validity of the digital signature of the payment transaction using the payer public key.

Step S33: constructing, after the validity of the payment transaction and the validity of the digital signature of the payment transaction are passed, a collection transaction corresponding to the payment transaction.

The above step S33, for example, may include: determining a transaction action type of the payment transaction, and determining a collection transaction corresponding to the transaction action type. For example, if the payee determines that the corresponding transaction type of the payee is collection based on the transaction type of the payment transaction being paying, the payee can convert the payment transaction into the content taking the payee as a main body through the transaction corresponding relationship, for example, the payment transaction is “Transferring 500 yuan to B”, then when B acts as the payee, B can convert the payment transaction into “Receiving 500 yuan transferred from A”.

Step S34: digitally signing the collection transaction using the private key of the payee, to obtain the digital signature of the collection transaction.

Optionally, in the present embodiment, after the collection transaction and the digital signature of the collection transaction are acquired, the collection transaction and the digital signature of the collection transaction also will be sent to the account book network, so that the account book network, after verifying the content of the collection transaction and the digital signature of the collection transaction, stores the collection transaction and the digital signature of the collection transaction. When the transaction is being verified or audited, the transaction content can be verified or audited efficiently and accurately through the transaction data stored in the account book network.

Optionally, after completing the storage of the collection transaction and the digital signature of the collection transaction, the coordinator node of the account book network may actively notify the payer and the payee that the identified payment transaction has been written into the account book (that is, the payment transaction has been completed), and broadcast a notification that the payment transaction has been completed to the whole network using the Gossip protocol or other broadcast protocols. Optionally, in addition to the manner in which the coordinator node actively notifies the payee or the payer, the payee or the payer may also actively query relevant transaction information.

Optionally, in addition to the above processing, the coordinator node in the account book network further may perform any other necessary work for the collection transaction, including but not limited to executing method processing, locking relevant assets, reaching consensus on transaction outcome, writing transaction into the account book and/or tracing sources, etc. The above processing may be performed by one coordinator independently or by a plurality of coordinators in cooperation. The work in these sections may be done synchronously and serially, or may be done asynchronously and concurrently.

Optionally, the coordinator node in the account book network further may notify the payee of an intermediate processing result, progress in the intermediate section of processing the collection transaction. Optionally, in addition to the manner in which the coordinator node actively notifies the payee or the payer, the payee or the payer may also actively acquire relevant transaction information.

The main points of the transaction processing method provided in the embodiment of the present disclosure are summarized as follows: two transaction parties use a shared account book for bookkeeping, wherein the shared account book usually exists in the form of account book network, there are a complete account book record in the account book network and multiple backups, and the record cannot be tampered illegally, or the cost of illegally tampering the record is quite high; two transaction parties have to use their own private keys to digitally sign the transaction content signed by oneself; two transaction parties and coordination nodes in the intermediate processing process verify the received transaction content and the digital signature of the transaction; in each transaction, two transaction parties only need to carry out one-time (single-entry) bookkeeping on the account book, and record the transaction on the shared account book, and the single-entry bookkeeping of both parties is combined in the shared account book to become a complete transaction record of the two parties.

Compared with the conventional double-entry bookkeeping method, the transaction processing method provided in the present embodiment relies on a computer network, cryptography, and computer algorithms, while the double-entry bookkeeping method does not rely on the same; the present method uses the shared account book, and all entities in the system share one account book, instead of one independent account book for each entity, and the account book is maintained by all entities participating in the bookkeeping; in the bookkeeping section, the double-entry bookkeeping is changed to the single-entry bookkeeping, that is to say, only one-time bookkeeping needs to be performed for each economic business for two transaction parties, and the bookkeeping work can be completed by a machine, but the double-entry bookkeeping method requires two transaction parties to bookkeep two times on their account books, respectively; in the present method, the two transaction parties not only need to confirm the digital signature of the content signed and issued by themselves, but also need to verify the content signed and issued by the opposite party, which may be regarded as achieving “cross verification, secondary confirmation”, then it is hard to make man-made mistakes again, and the fruits of labor in the transaction may be permanently reserved for subsequent verification at any time, thus further improving the working efficiency; the present transaction processing method no longer requires an invoice (or voucher) or the like as an bookkeeping document, it is unnecessary to collect invoice (or voucher) for reimbursement, and invoicing is no longer needed in business operations.

Finally, the advantages of the transaction processing method provided in the present disclosure are summarized:

1. Simplification in Flow

A. Analyzed from the flow, the original three sections become only one section: after the use of invoice is eliminated, obviously, the originally indispensable invoicing (invoice production), and invoice collection (invoice use) sections disappear, thereby simplifying the operation process of the enterprises and organizations, and reducing the cost. When there is no invoice-related section, the enterprises only need to focus on the problems in the bookkeeping section (unrelated to invoice).

B. In the bookkeeping section, it is realized that the transaction is equivalent to the bookkeeping.

When the transaction is completed, the bookkeeping is completed, that is, the two sections of transaction and bookkeeping are integrated into one section, which may save labor. Thus, it is unnecessary to manually perform verification repeatedly in the future (this is a big reason for inefficiency of the double-entry bookkeeping method).

C. Atomization of transaction is realized, and robust foundation is laid for improving system performance and scalability of the distributed account books. Whether it is payment transaction or collection transaction, only data reading/writing of one account is involved, which is so-called atomization of transaction; and the atomization of transaction is the basis of many optimization measures for performance and scalability.

Atomization:

1. the operation in the business must be transformed into an indivisible work unit; and

2. the operations in the business either all happen or none of them happen (this one has been done, and will not be discussed here).

Neither UTXO of Bitcoin nor Ethereum has achieved item 1, and to achieve item 1, “isolation between cause and effect, first cause and then effect” has to be realized, and the reasons are analyzed as follows:

1. the height of the same block may be regarded as time, then all transactions in the same block have a simultaneity relationship;

2. as the two operations of “send” and “receive” have a causal relationship, and cause and effect certainly cannot occur at the same time, there must be a sequential order, therefore, the two should not be in the same block, only can be collected in two different blocks, and must ensure that the cause (send) comes first, and the result (receive) comes later; and

3. the method of UTXO or Ethereum puts the two operations of “send” and “receive” having a causal relationship in one block, which obviously violates the law of causality.

2. Analysis from Consumer's Perspective

A. Not only the resource allocation cost may be reduced, but also the convenient and quick service experience can be enjoyed. It is no longer necessary to queue and wait for invoicing, collect the invoices, or worry about loss of invoices, and there is no trouble of gluing the invoices.

B. The consumer no longer needs the invoice or voucher, and receipt, so that the reimbursement is simpler; and the transaction information on the account book can be directly inquired as long as the transaction ID is provided.

3. Analysis from Perspectives of Enterprises and Organizations

A. The disappearance of the invoice (or voucher) may save a lot of economic costs and efforts for both the original invoice (or voucher) issuer and the original invoice (or voucher) receiver.

B. The disappearance of the invoice (or voucher) makes the consumers' experience easier and smoother.

C. The single-entry bookkeeping reduces half of the workload, and the remaining work may also be completed by a machine, then simplifying the work and improving the efficiency while reducing the cost.

D. The bookkeeping section (unrelated to the invoice) of the present method also may make it harder to counterfeit or make mistake while reducing the workload, thus reducing the human cost to a greater extent.

E. The whole bookkeeping and reimbursement process is simpler, and is paper-free, unmanned, and fully automated.

4 Analysis from the Perspective of Tax Authority and Related Departments

A. The tax system is expected to change from “managing tax with invoice” to direct tax collection, which not only may eliminate the huge economic loss caused by counterfeiting of the invoices, but also can replace human workers with a machine, thus greatly improving the tax control ability, reducing the bookkeeping cost of the enterprises, and improving the efficiency.

B. Because of the existence of bookkeeping mechanism with cross verification and secondary confirmation, many counterfeiting behaviors may be restrained, especially various cross-enterprise counterfeiting behaviors, and auditing may be performed more easily.

C. The cost of the tax control is reduced, the tax base is enlarged, more revenue may be brought about, the tax rate is decreased, and the operation cost of the enterprises is reduced.

5. Analysis from the Perspective of the Whole Society

A. The counterfeiting behaviors of enterprises are restrained, the overall running cost of the society is decreased, and the social running friction is reduced, thus forming more healthy and more positive commercial civilization, which will form new, and more competitive commercial civilization.

B. The data island effect may be eliminated, the workflow is simplified, and the data storage efficiency is improved.

In order to cooperate with the transaction processing method applied to a payer provided in the present embodiment, the present embodiment further provides a transaction processing apparatus 40 applied to the payer.

Referring to FIG. 4, FIG. 4 is a modular schematic view of the transaction processing apparatus applied to a payer provided in an embodiment of the present disclosure.

The transaction processing apparatus 40 may include:

a payment transaction constructing module 41, configured to construct a payment transaction;

a first signing module 42, configured to digitally sign the payment transaction using a private key of the payer, to obtain a digital signature of the payment transaction;

a first storage module 43, configured to store the payment transaction and the digital signature of the payment transaction; and

a broadcasting module 44, configured to broadcast the payment transaction and the digital signature of the payment transaction to the account book network, so that the payee receives the payment transaction and the digital signature of the payment transaction from the account book network, verifies the validity of the payment transaction, and verifies the validity of the digital signature of the payment transaction using a public key of the payer, constructs a collection transaction corresponding to the payment transaction after the validity of the payment transaction and the validity of the digital signature of the payment transaction are passed, and digitally signs the collection transaction using a private key of the payee to obtain the digital signature of the collection transaction.

Optionally, the transaction processing apparatus 40 further may include: a first key module, configured to generate the private key of the payer and the public key of the payer based on an algorithm specified by the account book network, and store the private key of the payer and the public key of the payer.

Optionally, the transaction processing apparatus 40 further may include: a first registration module, configured to send the public key of the payer to the account book network for registration; receive and store a payer identifier returned by the account book network when the registration succeeds, wherein the payer registers only when accessing the account book network for the first time, and generates the private key of the payer and the public key of the payer only when registering.

In order to cooperate with the transaction processing method applied to a payee provided in the present embodiment, the present embodiment further provides a transaction processing apparatus 50 applied to a payee.

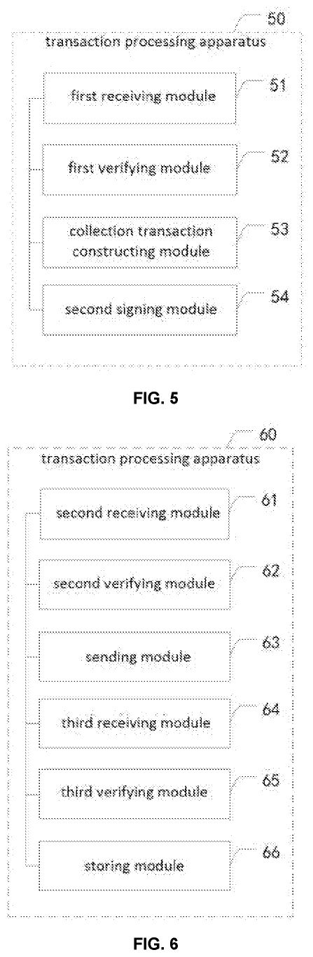

Referring to FIG. 5, FIG. 5 is a modular schematic view of the transaction processing apparatus applied to a payee provided in an embodiment of the present disclosure.

The transaction processing apparatus 50 includes:

a first receiving module 51, configured to receive a payment transaction and a digital signature of the payment transaction from an account book network;

a first verifying module 52, configured to verify the validity of the payment transaction, and verify the validity of the digital signature of the payment transaction using the public key of the payer;

a collection transaction constructing module 53, configured to construct, after the validity of the payment transaction and the validity of the digital signature of the payment transaction are passed, a collection transaction corresponding to the payment transaction; and

a second signing module 54, configured to digitally sign the collection transaction using a private key of the payee, to obtain the digital signature of the collection transaction.

Optionally, the transaction processing apparatus 50 further may include: a second key module, configured to generate the private key of the payee and the public key of the payee based on an algorithm specified by the account book network, and store the private key of the payee and the public key of the payee.

Optionally, the transaction processing apparatus 50 further may include: a second registration module, configured to send the public key of the payee to the account book network for registration; receive and store a payee identifier returned by the account book network when the registration succeeds, wherein the payee registers only when accessing the account book network for the first time, and generates the private key of the payee and the public key of the payee only when registering.

Optionally, the collection transaction constructing module 53 may be specifically configured to: determine a transaction action type of the payment transaction, and determine a collection transaction corresponding to the transaction action type.

In order to cooperate with the transaction processing method applied to an account book network provided in the present embodiment, the present embodiment further provides a transaction processing apparatus 60 applied to an account book network.

With reference to FIG. 6, FIG. 6 is a modular schematic diagram of the transaction processing apparatus applied to an account book network provided in an embodiment of the present disclosure.

The transaction processing apparatus 60 may include:

a second receiving module 61, configured to receive the payment transaction and the digital signature of the payment transaction sent by the payer;

a second verifying module 62, configured to verify the validity of the payment transaction, and verify the validity of the digital signature of the payment transaction using the public key of the payer;

a sending module 63, configured to send, after the validity of the payment transaction and the validity of the digital signature of the payment transaction are passed, the payment transaction and the digital signature of the payment transaction to the payee directly or indirectly, so that the payee receives the payment transaction and the digital signature of the payment transaction from the account book network, verifies the validity of the payment transaction, and verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using the private key of the payee to obtain the digital signature of the collection transaction;

a third receiving module 64, configured to receive the collection transaction and the digital signature of the collection transaction sent by the payee;

a third verifying module 65, configured to verify the validity of the collection transaction, and verify the validity of the digital signature of the collection transaction using the public key of the payee; and

a storing module 66, configured to store, after the validity of the collection transaction and the validity of the digital signature of the collection transaction are passed, the collection transaction and the digital signature of the collection transaction.

An embodiment of the present disclosure further provides an electronic device, wherein the electronic device includes a memory and a processor, the memory stores a program instruction, and when the processor reads and runs the program instruction, the steps in the method of any one of the transaction processing methods provided in the present embodiment are executed.

Exemplarily, the electronic device may be a personal computer (PC), a tablet computer, a smartphone, a personal digital assistant (PDA), an embedded sensor device or electronic devices having a logical computing function.

An embodiment of the present disclosure further provides a readable storage medium, wherein a computer program instruction is stored in the readable storage medium, and when the computer program instruction is read and run by a processor, the steps in the transaction processing method are executed.

In summary, the embodiments of the present disclosure provide a transaction processing method, a transaction processing apparatus, an electronic device, and a storage medium, wherein the method applied to a payer may include: constructing the payment transaction; digitally signing the payment transaction using the private key of the payer to obtain the digital signature of the payment transaction; storing the payment transaction and the digital signature of the payment transaction; broadcasting the payment transaction and the digital signature of the payment transaction to the account book network, so that the payee receives the payment transaction and the digital signature of the payment transaction from the account book network, verifies the validity of the payment transaction, verifies the validity of the digital signature of the payment transaction using the public key of the payer, constructs the collection transaction corresponding to the payment transaction after the validity of the payment transaction and the validity of the digital signature of the payment transaction are passed, and digitally signs the collection transaction using the private key of the payee to obtain the digital signature of the collection transaction.

In the above implementations, the payer and the payee only need to locally record transactions related to oneself, but do not have to record transactions irrelevant thereto, thus the transaction recording workload is reduced, the transaction recording efficiency is improved, and meanwhile, the public and private keys are used to verify the transaction information, then cross verification and secondary confirmation of identity and transaction are realized, the counterfeiting space is reduced, the transaction safety is improved, and it is no longer necessary to make a paper invoice or voucher, thus reducing the bookkeeping cost.

In the several embodiments provided in the present disclosure, it should be understood that the device disclosed also may be realized in other manners. The apparatus embodiments described above are merely illustrative, for example, the blocks in the accompanying drawings show possible system structures, functions, and operations of the device according to multiple embodiments of the present disclosure. In this regard, each block in the block may represent a part of one module, program segment, or code, and a part of the module, the program segment, or the code contains one or more executable instructions configured to achieve a specified logical function. It also should be noted that in some implementations as substitution, the functions indicated in the blocks also may be performed in an order different from that indicated in the accompanying drawings. For example, two continuous blocks actually may be substantially executed in parallel, and they sometimes also may be executed in a reverse order, which depends upon a function involved. It also should be noted that each block in the block diagram, and combinations of the blocks may be realized by a dedicated hardware-based system configured to execute a specified function or action, or may be realized by a combination of dedicated hardware and computer instructions.

Besides, the various functional modules in various embodiments of the present disclosure may be integrated together to form one independent portion, and it is also possible that the various modules exist independently, or that two or more modules are integrated to form one independent part.

If the function is realized in a form of software functional module and is sold or used as an individual product, it may be stored in one computer readable storage medium. Therefore, an embodiment of the present disclosure further provides a readable storage medium, wherein a computer program instruction is stored in the readable storage medium, and when the computer program instruction is read and run by a processor, the steps in any one of the methods of block data storage are executed. Based on such understanding, the technical solutions in essence or parts making contribution to the prior art or parts of the technical solutions of the present disclosure may be embodied in form of a software product, and this computer software product is stored in a storage medium, including several instructions for making one computer device (which may be a personal computer, a server or a network device etc.) execute all or part of the steps of the methods of various embodiment of the present disclosure. Optionally, the aforementioned storage medium may include various media in which program codes can be stored, such as U disk, mobile hard disk, Read-Only Memory (ROM), Random Access Memory (RAM), diskette and compact disk.

The above-mentioned are merely for embodiments of the present disclosure and not used to limit the scope of protection of the present disclosure, and for one skilled in the art, various modifications and changes may be made to the present disclosure. Any modifications, equivalent substitutions, improvements and so on, within the spirit and principle of the present disclosure, should be covered within the scope of protection of the present disclosure. It should be noted that similar reference signs and letters represent similar items in the following accompanying drawings, therefore, once a certain item is defined in one accompanying drawing, it is not needed to be further defined or explained in subsequent accompanying drawings.

The above-mentioned are merely embodiments of the present disclosure, but the scope of protection of the present disclosure is not limited thereto, and any modification or substitution that may be easily envisaged by those skilled in the present art within the technical scope disclosed in the present disclosure should fall within the scope of protection of the present disclosure.

It should be indicated that in the present text, relational terms such as first and second are merely for distinguishing one entity or operation from another entity or operation, while it is not required or implied that these entities or operations necessarily have any such practical relation or order. Moreover, terms “include”, “contain” or any other derivatives thereof are intended to be non-exclusive, thus a process, a method, an article or a device including a series of elements not only include those elements, but also include other elements that are not listed definitely, or further include elements inherent to such process, method, article or device. Without more restrictions, an element defined with wordings “including . . . ” does not exclude presence of other same elements in the process, method, article or device including said element.

### INDUSTRIAL APPLICABILITY

For the transaction processing method, the transaction processing apparatus, the electronic device, and the storage medium provided in the embodiments of the present disclosure, the two transaction parties use the shared account book existing in a form of account book network for bookkeeping, the account book network has a complete account book record, with multiple backups, and the record cannot be tampered illegally, or the cost of illegally tampering the record is quite high; two transaction parties have to use their own private keys to digitally sign the transaction content signed by oneself; two transaction parties and coordination nodes in the intermediate processing process verify the received transaction content and the digital signature of the transaction; in each transaction, two transaction parties only need to carry out one-time (single-entry) bookkeeping on the account book, and record the transaction on the shared account book, and the single-entry bookkeeping of the two parties is combined in the shared account book to become a complete transaction record of the two parties.

As the payer and the payee only need to locally record transactions related to oneself, but do not have to record transactions irrelevant thereto, the transaction recording workload is reduced, and the transaction recording efficiency is improved; and meanwhile, the public and private keys are used to verify the transaction information, then cross verification and secondary confirmation of identity and transaction are realized, the counterfeiting space is reduced, and the transaction safety is improved; and it is no longer necessary to make a paper invoice or voucher, thus reducing the bookkeeping cost, further enabling the consumers to enjoy convenient and quick service experience; moreover, the whole bookkeeping and reimbursement process is simpler, and is paper-free, unmanned, and fully automated.

What is claimed is:

1. A transaction processing method applicable to a payer, wherein the method comprises:
constructing a payment transaction;
digitally signing the payment transaction using a private key of the payer, to obtain a digital signature of the payment transaction;
storing the payment transaction and the digital signature of the payment transaction; and
broadcasting the payment transaction and the digital signature of the payment transaction to an account book network, so that a payee receives the payment transaction and the digital signature of the payment transaction from the account book network, verifies a validity of the payment transaction, verifies a validity of the digital signature of the payment transaction using a public key of the payer, constructs a collection transaction corresponding to the payment transaction after the validity of the payment transaction and the validity of the digital signature of the payment transaction are passed, and digitally signs the collection transaction using a private key of the payee, to obtain a digital signature of the collection transaction.

2. The method according to claim 1, wherein the method further comprises: generating the private key of the payer and the public key of the payer based on an algorithm specified by the account book network, and storing the private key of the payer and the public key of the payer.

3. The method according to claim 1, wherein the method further comprises:
sending the public key of the payer to the account book network for registration; and
receiving and storing a payer identifier returned by the account book network when the registration succeeds,
wherein the payer registers only when accessing the account book network for the first time, and generates the private key of the payer and the public key of the payer only in an event that registration is needed.

4. A transaction processing method applicable to a payee, wherein the method comprises:
receiving a payment transaction and a digital signature of a payment transaction from an account book network;
verifying a validity of the payment transaction, and verifying a validity of the digital signature of the payment transaction using a public key of a payer;
constructing, after the validity of the payment transaction and the validity of the digital signature of the payment transaction are passed, a collection transaction corresponding to the payment transaction; and
digitally signing the collection transaction using a private key of the payee, to obtain a digital signature of the collection transaction.

5. The method according to claim 4, wherein after acquiring the collection transaction and the digital signature of the collection transaction, the payee sends the collection transaction and the digital signature of the collection transaction to the account book network, so that the account book network, after verifying the collection transaction and the digital signature of the collection transaction, stores the collection transaction and the digital signature of the collection transaction.

6. The method according to claim 4, wherein after completing storing the collection transaction and the digital signature of the collection transaction, a coordinator node of the account book network actively notifies the payer and the payee that an identified payment transaction has been written into an account book.

7. The method according to claim 4, wherein a coordinator node of the account book network notifies the payee of an intermediate processing result or progress in a process of processing the collection transaction.

8. The method according to claim 4, wherein the method further comprises:
generating the private key of the payee and a public key of the payee based on an algorithm specified by the account book network, and storing the private key of the payee and the public key of the payee.

9. The method according to claim 4, wherein the method further comprises:
sending the public key of the payee to the account book network for registration; and
receiving and storing a payee identifier returned by the account book network when the registration succeeds,
wherein the payee registers only when accessing the account book network for the first time, and generates the private key of the payee and the public key of the payee only in an event that registration is needed.

10. The method according to claim 4, wherein the constructing a collection transaction corresponding to the payment transaction comprises:
determining a transaction action type of the payment transaction, and constructing a corresponding collection transaction according to a determined transaction action type.

11. A transaction processing method applicable to an account book network, wherein the method comprises:
receiving a payment transaction and a digital signature of the payment transaction sent by a payer;
verifying a validity of the payment transaction, and verifying a validity of the digital signature of the payment transaction using a public key of the payer;
sending, after the validity of the payment transaction and the validity of the digital signature of the payment transaction are passed, the payment transaction and the digital signature of the payment transaction to a payee directly or indirectly, so that the payee receives the payment transaction and the digital signature of the payment transaction from the account book network, verifies the validity of the payment transaction, and verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using a private key of the payee, to obtain a digital signature of the collection transaction;
receiving the collection transaction and the digital signature of the collection transaction sent by the payee;
verifying a validity of the collection transaction, and verifying the validity of the digital signature of the collection transaction using a public key of the payee; and
storing, after the validity of the collection transaction and the validity of the digital signature of the collection transaction are passed, the collection transaction and the digital signature of the collection transaction, and sending the collection transaction and the digital signature of the collection transaction directly or indirectly to the payer.

12. The method according to claim 11, wherein the account book network verifies a transaction time of the payment transaction or the collection transaction, so as to determine whether a transaction is reasonable.

13. The method according to claim 11, wherein the payment transaction and the digital signature of the payment transaction are sent to the payee in a direct manner or in an indirect manner, wherein
the direct manner comprises that the payment transaction and the digital signature of the payment transaction are sent to the payee point-to-point through a node of the account book network, and
the indirect manner comprises that the account book network enables other nodes, by broadcasting in whole network, to indirectly send the payment transaction and the digital signature of the payment transaction to the payee.

14. The method according to claim 11, wherein a coordinator node of the account book network notifies the payer of an intermediate processing result or progress in a process of processing the payment transaction and the digital signature of the payment transaction.

15. A transaction processing apparatus applicable to a payer, wherein the apparatus comprises:
a payment transaction constructing module, configured to construct a payment transaction;
a first signing module, configured to digitally sign the payment transaction using a private key of the payer, to obtain a digital signature of the payment transaction;
a first storage module, configured to store the payment transaction and the digital signature of the payment transaction; and
a broadcasting module, configured to broadcast the payment transaction and the digital signature of the payment transaction to an account book network, so that a payee receives the payment transaction and the digital signature of the payment transaction from the account book network, verifies a validity of the payment transaction, and verifies a validity of the digital signature of the payment transaction using a public key of the payer, constructs a collection transaction corresponding to the payment transaction after the validity of the payment transaction and the validity of the digital signature of the payment transaction are passed, and digitally signs the collection transaction using a private key of the payee, to obtain a digital signature of the collection transaction.

16. A transaction processing apparatus applicable to a payee, wherein the apparatus comprises:
a first receiving module, configured to receive a payment transaction and a digital signature of the payment transaction from an account book network;
a first verifying module, configured to verify a validity of the payment transaction, and verify a validity of the digital signature of the payment transaction using a public key of a payer;
a collection transaction constructing module, configured to construct, after the validity of the payment transaction and the validity of the digital signature of the payment transaction are passed, a collection transaction corresponding to the payment transaction; and
a second signing module, configured to digitally sign the collection transaction using a private key of the payee, to obtain a digital signature of the collection transaction.

17. A transaction processing apparatus applicable to an account book network, wherein the apparatus comprises:
a second receiving module, configured to receive a payment transaction and a digital signature of the payment transaction sent by a payer;
a second verifying module, configured to verify a validity of the payment transaction, and verify a validity of the digital signature of the payment transaction using a public key of the payer;
a sending module, configured to send, after the validity of the payment transaction and the validity of the digital signature of the payment transaction are passed, the payment transaction and the digital signature of the payment transaction to a payee directly or indirectly, so that the payee receives the payment transaction and the digital signature of the payment transaction from the account book network, verifies the validity of the payment transaction, and verifies the validity of the digital signature of the payment transaction using the public key of the payer, constructs a collection transaction corresponding to the payment transaction after the validity of the payment transaction and the validity of the digital signature of the payment transaction are passed, and digitally signs the collection transaction using a private key of the payee, to obtain a digital signature of the collection transaction;
a third receiving module, configured to receive the collection transaction and the digital signature of the payment transaction sent by the payee;
a third verifying module, configured to verify a validity of the collection transaction, and verify a validity of the digital signature of the collection transaction using a public key of the payee; and
a storing module, configured to store, after the validity of the collection transaction and the validity of the digital signature of the collection transaction are passed, the collection transaction and the digital signature of the collection transaction, and sending the collection transaction and the digital signature of the collection transaction directly or indirectly to the payee.

18. An electronic device, wherein the electronic device comprises a memory and a processor, wherein the memory stores program instructions, and when the processor runs the program instructions, steps in the method according to claim 1 are executed.

19. A storage medium, wherein computer program instructions are stored in the storage medium, and when the computer program instructions are run by a processor, steps in the method according to claim 1 are executed.

20. The method according to claim 2, wherein the method further comprises:
sending the public key of the payer to the account book network for registration; and
receiving and storing a payer identifier returned by the account book network when the registration succeeds,
wherein the payer registers only when accessing the account book network for the first time, and generates the private key of the payer and the public key of the payer only in an event that registration is needed.
